(19) United States
(12) Patent Application Publication
(10) Pub. No.: US 2026/0172887 A1
(43) Pub. Date: Jun. 18, 2026

(54) DYNAMIC DEVICE COLLABORATION FOR EXTENDED REALITY (XR) DEVICES

(71) Applicant: Meta Platforms Technologies, LLC, Menlo Park, CA (US)

(72) Inventors: Zhu JI, Saratoga, CA (US); Avik SENGUPTA, San Jose, CA (US); Liwen YU, Santa Clara, CA (US)

(73) Assignee: Meta Platforms Technologies, LLC, Menlo Park, CA (US)

(21) Appl. No.: 19/412,331

(22) Filed: Dec. 8, 2025

Related U.S. Application Data
(60) Provisional application No. 63/733,664, filed on Dec. 13, 2024.

(51) Int. Cl. H04W 28/02; H04W 92/10

(52) U.S. Cl. CPC H04W 28/0257; H04W 28/0268; H04W 92/10

(57) ABSTRACT

In some embodiments, a first device may include a first network interface corresponding to a first wireless link connected to a cellular network, a second network interface corresponding to a second wireless link connected to a second device, a network stack including a first layer, and one or more processors. The one or more processors may obtain, at the first layer, a first set of values relating to the first wireless link and a second set of values relating to the second wireless link, determine, based at least on the first set of values and the second set of values, a first data rate and a second data rate that satisfy one or more criteria, wirelessly transmit, via the first network interface, first data at the first data rate, and wirelessly transmit, via the second network interface, second data at the second data rate.

### CROSS-REFERENCE TO RELATED APPLICATION

This application claims priority to U.S. Provisional Patent Application No. 63/733,664 filed on Dec. 13, 2024, which is incorporated by reference herein in its entirety for all purposes.

### FIELD OF DISCLOSURE

The present disclosure is generally related to wireless communication, including but not limited to systems and methods for a device to exchange data with a cellular network in collaboration with one or more other devices.

### BACKGROUND

Cellular communication technology (e.g., 3G, 4G, 5G) allows high data rate communication. In such an environment, a user equipment (UE) can generate and transmit data to a base station.

Extended reality (XR) technologies are increasingly utilized in applications that demand high data rates, low latency, high reliability, and/or robust coverage and mobility in order to deliver a seamless user experience. As XR platforms evolve, emerging use cases such as augmented reality (AR) video calling (e.g., codec avatar communication) and multimodal artificial intelligence (MMAI) introduce even more stringent latency requirements to enable real-time interactions and enhance user engagement.

Conventional approaches may be insufficient to meet these demands as the complexity and volume of XR data increase, particularly under dynamic cellular conditions. Accordingly, there exists a need to improve the overall quality of experience for users of XR systems in such environments.

### SUMMARY

Various embodiments disclosed herein are related to a first device. The first device may include a first network interface, a second network interface, a network stack, and one or more processors. The first network interface may correspond to a first wireless link connected to a cellular network. The second network interface may correspond to a second wireless link connected to a second device. The network stack may include a first layer that configures the first and second network interfaces to communicate data with the cellular network. The one or more processors may be configured to obtain, at the first layer, a first set of values relating to the first wireless link and a second set of values relating to the second wireless link. The one or more processors may be configured to determine, based at least on the first set of values and the second set of values, a first data rate and a second data rate that satisfy one or more criteria. The one or more processors may be configured to wirelessly transmit, via the first network interface, first data to the cellular network at the first data rate. The one or more processors may be configured to wirelessly transmit, via the second network interface, second data to the second device at the second data rate.

Various embodiments disclosed herein are related to a method for a first device to communicate data with a cellular network. The first device may include one or more processors, a first network interface corresponding to a first wireless link connected to the cellular network, a second network interface corresponding to a second wireless link connected to a second device, and a network stack including a first layer that configures the first and second network interfaces to communicate the data with the cellular network. The method may include obtaining, by the one or more processors, at the first layer, a first set of values relating to the first wireless link and a second set of values relating to the second wireless link. The method may include determining, by the one or more processors, based at least on the first set of values and the second set of values, a first data rate and a second data rate that satisfy one or more criteria. The method may include wirelessly transmitting, via the first network interface, first data to the cellular network at the first data rate. The method may include wirelessly transmitting, via the second network interface, second data to the second device at the second data rate.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram showing example components of a base station and a user equipment, according to an example implementation of the present disclosure.

FIG. 3 is a diagram showing example protocol stacks of a base station and a user equipment in a cellular network, according to an example implementation of the present disclosure.

FIG. 4A is a diagram showing an example of dynamic multi-device collaboration over a collaboration link, according to an example implementation of the present disclosure.

FIG. 4B is a diagram showing an example of dynamic multi-device collaboration between two devices shown in FIG. 4A.

FIG. 5A is a diagram showing another example of dynamic multi-device collaboration over a collaboration link, according to an example implementation of the present disclosure.

FIG. 5B is a diagram showing an example of dynamic multi-device collaboration between three devices shown in FIG. 5A.

FIG. 6 is a flowchart showing a process for a device to exchange data with a cellular network in collaboration with one or more other devices, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

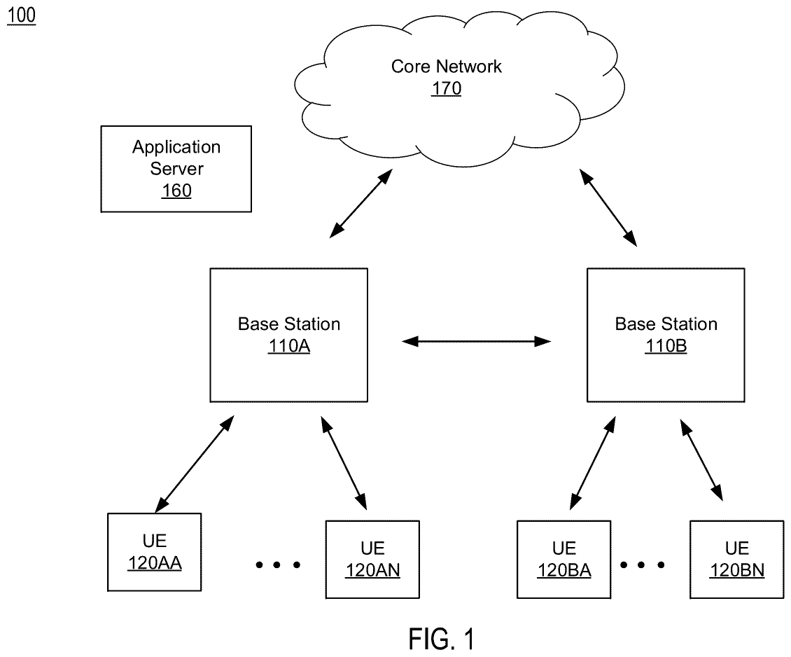

FIG. 1 illustrates an example wireless communication system 100. The wireless communication system 100 may include base stations 110A, 110B (also referred to as “wireless communication nodes 110” or “stations 110”) and user equipments (UEs) 120AA . . . 120AN, 120BA . . . 120BN (also referred to as “wireless communication devices 120” or “terminal devices 120”). The wireless communication link may be a cellular communication link conforming to 3G, 4G, 5G, 6G or other cellular communication protocols. In one example, the wireless communication link supports, employs or is based on an orthogonal frequency division multiple access (OFDMA). In one aspect, the UEs 120AA . . . 120AN are located within a geographical boundary with respect to the base station 110A, and may communicate with or through the base station 110A. Similarly, the UEs 120BA . . . 120BN are located within a geographical boundary with respect to the base station 110B, and may communicate with or through the base station 110B. A network between UEs 120 and the base stations 110 may be referred to as radio access network (RAN). In some embodiments, the wireless communication system 100 includes more, fewer, or different number of base stations 110 than shown in FIG. 1.

In some embodiments, the UE 120 may be a user device such as a mobile phone, a smart phone, a personal digital assistant (PDA), tablet, laptop computer, wearable computing device (e.g., head mounted display, smart watch), etc. Each UE 120 may communicate with the base station 110 through a corresponding communication link. For example, the UE 120 may transmit data to a base station 110 through a wireless communication link (e.g., 3G, 4G, 5G, 6G or other cellular communication link), and/or receive data from the base station 110 through the wireless communication link (e.g., 3G, 4G, 5G, 6G or other cellular communication link). Example data may include audio data, image data, text, etc. Communication or transmission of data by the UE 120 to the base station 110 may be referred to as an uplink communication. Communication or reception of data by the UE 120 from the base station 110 may be referred to as a downlink communication.

In some embodiments, the base station 110 may be an evolved node B (eNB), a gNodeB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations.

In some embodiments, the wireless communication system 100 includes a core network 170. The core network 170 may be a component or an aggregation of multiple components that ensures reliable and secure connectivity to the network for UEs 120. The core network 170 may be communicatively coupled to one or more base stations 110A, 110B through a communication link. A communication link between the core network 170 and a base station 110 may be a wireless communication link (e.g., 3G, 4G, 5G, 6G or other cellular communication link) or a wired communication link (e.g., Ethernet, optical communication link, etc.). In some embodiments, the core network 170 includes user plane function (UPF), access and mobility management function (AMF), policy control function (PCF), etc. The UPF may perform packet routing and forwarding, packet inspection, quality of service (QoS) handling, and provide external protocol data unit (PDU) session for interconnecting data network (DN). The AMF may perform registration management, reachability management, connection management, etc. The PCF may help operators (or operating devices) to easily create and seamlessly deploy policies in a wireless network. The core network 170 may include additional components for managing or controlling operations of the wireless network. In one aspect, the core network 170 may receive a message to perform a network congestion control, and perform the requested network congestion control. For example, the core network 170 may receive explicit congestion notification (ECN) from a base station 110 and/or a UE 120, and perform a network congestion control according to the ECN. For example, the core network 170 may adjust or control an amount of data generated, in response to the ECN. Additionally or alternatively, the core network 170 may adjust or control an amount of data transmitted and/or received, in response to the ECN.

In some embodiments, the wireless communication system 100 includes an application server 160. The application server 160 may be a component or a device that generates, manages, or provides content data. The application server 160 may be communicatively coupled to one or more base stations 110A, 110B through a communication link. A communication link between an application server 160 and a base station 110 may be a wireless communication link (e.g., 3G, 4G, 5G, 6G or other cellular communication link) or a wired communication link (e.g., Ethernet, optical communication link, etc.). In one aspect, an application server 160 may receive a request for data from a UE 120 through a base station 110, and provide the requested data to the UE 120 through the base station 110. In one aspect, an application server 160 may receive a message to perform a network congestion control, and perform the requested network congestion control. For example, the application server 160 may receive explicit congestion notification (ECN) from a base station 110, a UE 120, or a core network 170, and perform a network congestion control according to the ECN. For example, the application server 160 may adjust or control an amount of data generated, in response to the ECN. Additionally or alternatively, the application server 160 may adjust or control an amount of data transmitted and/or received, in response to the ECN. Additionally or alternatively, the application server 160 may adaptively adjust or control an error correct rate. An error correction rate may be a rate of a number of error correction packets (also referred to as “protection packets”) per a set of packets for transmission. An error correction packet can be provided to help recover content. The application server 160 may adaptively adjust the error correction rate, according to a signal quality of a signal received by a UE 120 or a location of the UE 120 with respect to one or more base stations 110.

In some embodiments, communication among the base stations 110, the UEs 120, application server 160, and the core network 170 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

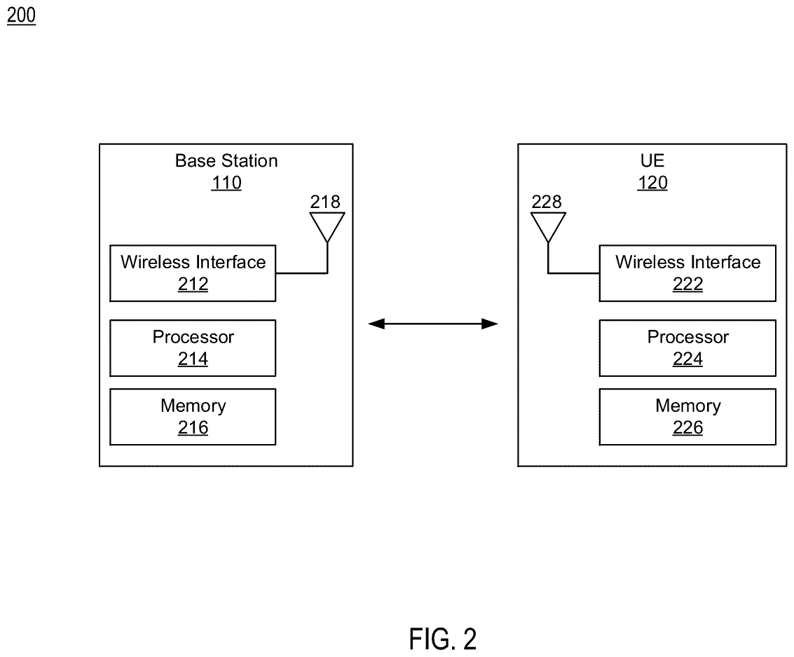

FIG. 2 is a diagram showing example components of a base station 110 and a user equipment 120, according to an example implementation of the present disclosure. In some embodiments, the UE 120 includes a wireless interface 222, a processor 224, a memory device 226, and one or more antennas 228. These components may be embodied as hardware, software, firmware, or a combination thereof. In some embodiments, the UE 120 includes more, fewer, or different components than shown in FIG. 2. For example, the UE 120 may include an electronic display and/or an input device. For example, the UE 120 may include additional antennas 228 and wireless interfaces 222 than shown in FIG. 2.

The antenna 228 may be a component that receives a radio frequency (RF) signal and/or transmits a RF signal through a wireless medium. The RF signal may be at a frequency between 200 MHz to 100 GHz. The RF signal may have packets, symbols, or frames corresponding to data for communication. The antenna 228 may be a dipole antenna, a patch antenna, a ring antenna, or any suitable antenna for wireless communication. In one aspect, a single antenna 228 is utilized for both transmitting a RF signal and receiving a RF signal. In one aspect, different antennas 228 are utilized for transmitting the RF signal and receiving the RF signal. In one aspect, multiple antennas 228 are utilized to support multiple-in, multiple-out (MIMO) communication.

The wireless interface 222 includes or is embodied as a transceiver for transmitting and receiving RF signals through one or more antennas 228. The wireless interface 222 may communicate with a wireless interface 212 of the base station 110 through a wireless communication link. In one configuration, the wireless interface 222 is coupled to one or more antennas 228. In one aspect, the wireless interface 222 may receive the RF signal at the RF frequency received through an antenna 228, and downconvert the RF signal to a baseband frequency (e.g., 0˜1 GHz). The wireless interface 222 may provide the downconverted signal to the processor 224. In one aspect, the wireless interface 222 may receive a baseband signal for transmission at a baseband frequency from the processor 224, and upconvert the baseband signal to generate a RF signal. The wireless interface 222 may transmit the RF signal through the antenna 228.

The processor 224 is a component that processes data. The processor 224 may be embodied as field programmable gate array (FPGA), application specific integrated circuit (ASIC), a logic circuit, etc. The processor 224 may obtain instructions from the memory device 226, and execute the instructions. In one aspect, the processor 224 may receive downconverted data at the baseband frequency from the wireless interface 222, and decode or process the downconverted data. For example, the processor 224 may generate audio data or image data according to the downconverted data, and present an audio indicated by the audio data and/or an image indicated by the image data to a user of the UE 120. In one aspect, the processor 224 may generate or obtain data for transmission at the baseband frequency, and encode or process the data. For example, the processor 224 may encode or process image data or audio data at the baseband frequency, and provide the encoded or processed data to the wireless interface 222 for transmission.

The memory device 226 is a component that stores data. The memory device 226 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 226 may be embodied as a non-transitory computer readable medium storing instructions executable by the processor 224 to perform various functions of the UE 120 disclosed herein. In some embodiments, the memory device 226 and the processor 224 are integrated as a single component.

In some embodiments, the base station 110 includes a wireless interface 212, a processor 214, a memory device 216, and one or more antennas 218. These components may be embodied as hardware, software, firmware, or a combination thereof. In some embodiments, the base station 110 includes more, fewer, or different components than shown in FIG. 2. For example, the base station 110 may include an electronic display and/or an input device. For example, the base station 110 may include additional antennas 218 and wireless interfaces 212 than shown in FIG. 2.

The antenna 218 may be a component that receives a radio frequency (RF) signal and/or transmits a RF signal through a wireless medium. The antenna 218 may be a dipole antenna, a patch antenna, a ring antenna, or any suitable antenna for wireless communication. In one aspect, a single antenna 218 is utilized for both transmitting a RF signal and receiving a RF signal. In one aspect, different antennas 218 are utilized for transmitting the RF signal and receiving the RF signal. In one aspect, multiple antennas 218 are utilized to support multiple-in, multiple-out (MIMO) communication.

The wireless interface 212 includes or is embodied as a transceiver for transmitting and receiving RF signals through one or more antennas 218. The wireless interface 212 may communicate with a wireless interface 222 of the UE 120 through a wireless communication link. In one configuration, the wireless interface 212 is coupled to one or more antennas 218. In one aspect, the wireless interface 212 may receive the RF signal at the RF frequency received through antenna 218, and downconvert the RF signal to a baseband frequency (e.g., 0˜1 GHz). The wireless interface 212 may provide the downconverted signal to the processor 214. In one aspect, the wireless interface 212 may receive a baseband signal for transmission at a baseband frequency from the processor 214, and upconvert the baseband signal to generate a RF signal. The wireless interface 212 may transmit the RF signal through the antenna 218.

The processor 214 is a component that processes data. The processor 214 may be embodied as FPGA, ASIC, a logic circuit, etc. The processor 214 may obtain instructions from the memory device 216, and execute the instructions. In one aspect, the processor 214 may receive downconverted data at the baseband frequency from the wireless interface 212, and decode or process the downconverted data. For example, the processor 214 may generate audio data or image data according to the downconverted data. In one aspect, the processor 214 may generate or obtain data for transmission at the baseband frequency, and encode or process the data. For example, the processor 214 may encode or process image data or audio data at the baseband frequency, and provide the encoded or processed data to the wireless interface 212 for transmission. In one aspect, the processor 214 may set, assign, schedule, or allocate communication resources for different UEs 120. For example, the processor 214 may set different modulation schemes, time slots, channels, frequency bands, etc. for UEs 120 to avoid interference. The processor 214 may generate data (or UL CGs) indicating configuration of communication resources, and provide the data (or UL CGs) to the wireless interface 212 for transmission to the UEs 120.

The memory device 216 is a component that stores data. The memory device 216 may be embodied as RAM, flash memory, ROM, EPROM, EEPROM, registers, a hard disk, a removable disk, a CD-ROM, or any device capable for storing data. The memory device 216 may be embodied as a non-transitory computer readable medium storing instructions executable by the processor 214 to perform various functions of the base station 110 disclosed herein. In some embodiments, the memory device 216 and the processor 214 are integrated as a single component.

In one aspect, extended reality (XR)/augmented reality (AR) wearable systems (e.g., smart glasses, watches, wristbands, pucks, phone devices), may operate under stringent industrial design (e.g., form factor and size), power constraints that limit on-device radio capability (e.g., modem size, transceiver count, antenna aperture/efficiency), and thermal budget. These limits, combined with dynamic cellular conditions (e.g., cell-edge interference, multipath fading, Doppler under mobility, network loading, and handover interruptions), may make it difficult for a single wearable to consistently meet the low-latency and medium-to-high throughput requirements of immersive communication, multimodal/generative AI (GenAI) services, and AR gaming. Here, the puck refers to a compute puck used in AR devices. The puck can contain substantial computing power and/or custom AI chips, allowing the AR devices (e.g., smart glasses, AR glasses) to function effectively. The puck can be carried separately and communicate with AR devices (e.g., smart glasses) to provide an immersive experience. The challenge may be exacerbated in uplink-dominant scenarios (e.g., image/video bursts for cloud AI processing), where power-limited wearables may struggle to sustain the required link capacity while preserving battery life. Existing multi-UE aggregation techniques do not fully consider AR-specific use-case needs or the real-time dynamics of coordinating collaboration among a heterogeneous wearable constellation. For example, AR devices can enable immersive and AI-driven use cases through a constellation of devices, including a pair of AR glasses equipped with a cutting-edge display, a wristband that enables seamless interaction via voice, eye gaze, hand tracking, and electromyography (EMG) technology, and a compute puck that keeps users connected to their surroundings and the broader world. The use cases for AR wearables can also encompass immersive communication, multimodal artificial intelligence (MMAI) and GenAI applications, and gaming. Immersive communication scenarios may demand low latency and medium to high data rates, while MMAI and GenAI use cases require low latency with bursty traffic, such as image or video uploads for cloud GenAI processing. This bursty traffic may translate into high, bursty data rates to ensure low latency. For example, smooth AR gaming experiences may depend on robust cellular connections, particularly in dynamic cellular environments.

Wireless communication for AR wearables may face several challenges due to the dynamic nature of cellular networks. Signal strength may vary depending on the device's position within the cell—whether near the cell center, mid-cell, or at the cell edge. Channels may be subject to fading caused by multipath propagation and Doppler effects, while network loading and mobility, including handover events, further complicate connectivity. In mobility scenarios, time-domain fading induced by Doppler can impair signals, and devices may need to handover from one base station to another to maintain continuity, with the handover process potentially causing interruptions in data transmission. At the cell edge, weak signal strength leads to low cellular data rates, and intercell interference for both uplink and downlink can be high, resulting in low SNR and reduced data rates. Loaded scenarios arise when multiple users require data connections simultaneously; depending on the scheduling algorithms, such as round robin, individual users may experience lower data rates as radio resources are shared. Consequently, the requirements for low latency in MMAI use cases or AR gaming, and the higher data rate requirements for immersive communication, may not be met in these dynamic cellular scenarios. AR wearable devices may be further constrained by form factor and size. Glasses and wrist wearables may be limited in space for cellular modems, radio frequency (RF) transceivers, and antennas, as space may be allocated for application processors, sensors, batteries, and/or connectivity chipsets such as Wi-Fi and Bluetooth. Power and thermal constraints may be more stringent for glasses and wristwear due to limited battery size and volume available for thermal dissipation, especially when compared to smartphones or puck-like communication devices. The form factor limitation also may affect the ability to perform powerful on-device compute, such as running large language model (LLM) models for MMAI, resulting in increased traffic sent to the cloud for processing. For example, MMAI uplink data rate requirements for sending pictures at different resolutions and sampling rates illustrate the high link capacity demands placed on AR wearables that are both power and size limited. Cellular uplink may be often power limited, and data rate can become the bottleneck for devices such as the puck, watch, and phone as the resolution and/or the frame rate increases (see Table 1 below).

TABLE 1
Data Rate Requirements for Different Resolution Frame Rates

| | Raw | 10:1 | Interlink Data | Interlink Data |
|---|---|---|---|---|
| Resolution and | Size | JPEG | Rate (1 Mbps) | Rate (1 Mbps) |
| Frame Rate | (MB) | (MB) | 1 sec one-way | 200 ms one-way |
| (432 × 576, 2) | 0.75 | 0.07 | 0.60 | 3.0 |
| (432 × 576, 5) | 1.98 | 0.19 | 1.49 | 7.45 |
| (432 × 576, 10) | 3.73 | 0.37 | 2.99 | 14.95 |
| (960 × 1280, 5) | 9.22 | 0.92 | 7.37 | 36.85 |
| (1440 × 1440, 5) | 15.55 | 1.56 | 12.44 | 62.2 |
| (4032 × 3008, 2) | 36.38 | 3.64 | 29.11 | 145.55 |

To address these problems, the present disclosure includes systems, devices, and methods for implementing dynamic multi-device collaboration techniques that can improve the overall quality of experience for users of XR systems. In some embodiments, XR/AR wearable constellations can perform dynamic multi-device collaboration across a cellular interlink and short-range interlinks to improve data rate, latency, power efficiency, and robustness for XR/AR use cases. The XR/AR wearable constellations refers to a set of multiple AR-capable user equipments (UEs). In some embodiments, a cellular interlink may refer to a wireless communication link established between an individual UE (e.g., AR glasses, wristband, or compute puck) and a cellular base station (e.g., 4G/5G tower). In some embodiments, a short-range interlink may refer to a wireless communication link established directly between two or more nearby devices or UEs, using short-range wireless technologies like Wi-Fi Direct, Bluetooth, ultra-wideband (UWB), or near field communication (NFC).

In some embodiments, systems and methods can provide dynamic multi-device collaboration schemes to meet stringent AR QoS requirements under real-world cellular dynamics and wearable constraints. In some embodiments, systems and methods can perform dynamic device collaboration among a plurality of UEs (e.g., XR/AR wearables that form a constellation, such as glasses, watch/wristband, puck/phone) to cooperatively share a cellular uplink traffic and/or a cellular downlink traffic while exchanging high-rate data over proximate intralinks (e.g., Wi-Fi/Bluetooth). In some embodiments, systems and methods can selects an anchor device (also referred to as “anchor UE”, “source device/UE”, “sync device/UE”) corresponding to the application's final destination (e.g., glasses for visual experiences; a watch for watch-native experiences) and perform real-time optimization of traffic split, power budgets, and fusion/combining latency across participating UEs. In some embodiments, an anchor device may refer to an UE that hosts the final application experience and acts as the sink for downlink reassembly and the source for uplink aggregation/partition decisions. In some embodiments, selection of the anchor device may be application-specific. For example, for AR rendering applications, smart glasses may be selected, and for watch-native interfaces, a watch may be selected as an anchor device.

In some embodiments, the 5G NR (5th Generation New Radio) protocol stack may include several layers including Layer 1 (PHY, or physical layer), Layer 2 (MAC, RLC, PDCP), and Layer 3 (RRC and NAS). In some embodiments, systems and methods can implement, realize, or create a collaboration layer (also referred to as “cooperation layer” or “intralink layer”) at different layers of a cellular stack (e.g., PDCP, or a transport layer above PDCP/RLC/MAC/PHY) to create a cooperation link (also referred to as “collaboration link” or “intralink”), with appropriate signaling between collaborating UEs and the base station (BS) or network to coordinate split and reassembly of data. In some embodiments, the cooperation link may refer to a short-range, higher-rate interconnection (e.g., Wi-Fi, Bluetooth, Wi-Fi Direct, UWB, NFC) among collaborating UEs used for control and payload exchange to enable aggregation and/or fusion.

In some embodiments, data split and collaboration may occur at the PDCP layer, or at lower layers such as RLC, MAC, or PHY, where finer control and faster adaptivity to 5G system dynamics are possible. In some embodiments, data split and collaboration can be performed at the transport layer above PDCP/RLC/MAC/PHY, where collaboration parameters and schemes may be updated less frequently compared to 5G RAN (radio access network) solutions. Collaboration at the PDCP layer can offer a tradeoff between dynamism and native support of 5G systems, while transport layer collaboration can provide less dynamism and does not require native 5G support. Collaboration at lower layers (e.g., PDCP/RLC/MAC/PHY) can enable dynamic schemes that adapt to delay-sensitive applications.

In some embodiments, a collaboration layer can be implemented at multiple protocol layers for appropriate signaling between collaborating UEs and/or between US and a BS (or cellular network). For example, Layer 2 protocols (e.g., PDCP) can coordinate or perform data split and reordering across collaborating UEs within the cellular stack. Layer 2 protocols can use Inter-UE and/or UE-BS signaling to synchronize sequence numbers, duplication/elimination policies, and/or buffer management. Lower layers (e.g., RLC/MAC/PHY) can perform finer-grain control enabling faster adaptation to channel dynamics, potentially improving delay-sensitive use cases at the cost of greater native RAN support. Transport/application layer can implement collaboration above the lower layers (e.g., PDCP/RLC/MAC/PHY) with reduced need for native RAN features such that signaling (e.g., control messages) rides over transport protocols, trading some dynamism for broader deployment flexibility. In this manner, the dynamic device collaboration can achieve higher aggregate data rates, reduced end-to-end latency, and/or improved robustness to adverse radio conditions, while distributing power consumption across devices to respect wearable thermal/energy limits.

In some embodiments, multiple devices can collaborate to achieve higher aggregated uplink and downlink data rates from an interlink. In some embodiments, the interlink may refer to a connection between devices and cellular base stations. In some embodiments, data can be aggregated on one of the collaborating devices (e.g., an anchor device or anchor UE), through an intralink, which is a connection between the collaborating UEs. In some embodiments, the intralink (e.g., Wi-Fi link) can provide much higher data rates than the interlink due to the physical adjacency of the devices. In some embodiments, aggregated data rates can achieve up to 100% improvements compared to each individual interlink.

In some embodiments, a source AR device may use tethering to communicate data with (or “tethered to”) one of the collaborating UEs. In some embodiments, the tethering may refer to the process of sharing a device's internet connection (typically a mobile phone or cellular-enabled device) with other devices using a wired (e.g., USB) link or a wireless (e.g., Wi-Fi, Bluetooth) link. The device providing the connection can act as a gateway, allowing the tethered devices to access the internet through its cellular or Wi-Fi network.

In some embodiments, systems and methods can use objective functions and/or constraints to perform dynamic multi-device (e.g., XR/AR wearables) collaboration. For example, a system (e.g., an anchor device/UE or any collaborating device/UE) may determine collaboration parameters (e.g., data rate per collaborating device) by solving objective functions. In some embodiments, the objective function may refer to a mathematical expression or formula that defines the goal of an optimization problem (e.g., maximizing or minimizing such as cost, profit, data rate, latency, or energy consumption) subject to certain constraints.

In some embodiments, the system may use an objective function to maximize a total data rate constrained by power consumption of collaborating devices (for example, 500 mW for wrist wearables or glasses wearables). In some embodiments, the total data rate may refer to the sum of data rates assigned to respective collaborating devices. In some embodiments, the system may use an objective function to minimize a total power consumption constrained by a target combined data rate which can be use case-specific, e.g., determined by the corresponding use case. In some embodiments, the system may use an objective function to minimize the end-to-end latency in the corresponding use case. In some embodiments, the end-to-end latency may refer to the total time it takes for data, a signal, or a message to travel from its source (e.g., origin) to its final destination across a system or network. The end-to-end latency can measure the delay between the moment data is generated (or requested) and the moment it is received and processed at the endpoint. For example, the system can minimize an end-to-end latency between an anchor device and a base station.

In some embodiments, the objective functions may be functions of variables influencing the goals of the objective functions. In some embodiments, the variables may relate to communication links (e.g., interlink and intralink (cooperation link)). For example, the variables may include channel conditions of the interlink, achievable data rates of the interlink, power efficiency (energy per bit) of the interlink, cellular system congestion levels of the interlink, mobility status of the device providing the interlink, and/or an end-to-end latency. In some embodiments, the end-to-end latency may depend on the anchor UE and may be affected by the number of antennas and antenna efficiency of the collaborating devices (e.g., XR/AR wearables). In some embodiments, the variables may include channel conditions of the intralink (cooperation link), achievable data rates of the cooperation link, power efficiency (energy per bit) of the cooperation link, cellular system congestion levels of the collaborating devices, mobility status of the collaborating devices, and/or power efficiency of the cooperation link.

In some embodiments, the system (e.g., anchor device) can use an objective function to maximize a total data rate constrained by power consumption, using variables including achievable data rates (r1 and r2) of both the interlink and the cooperation link, power efficiency (e1 and e2 in energy per bit) of both links, and power constraints (P1 and P2) of both links (e.g., power consumption of the interlink and/or the anchor device and power consumption of the cooperation link and/or the collaborating device). The total data rate may refer to the sum of data rates of both the intelink and the cooperation link. In some embodiments, the system (e.g., anchor device) can determine the data rates split between UEs (e.g., the anchor UE and collaborating UE) by solving the objective function. In some embodiments, the system can maximize a total (aggregate) data rate under total or per-device power constraints (e.g., sum of power≤a target budget; or power≤an asymmetric budget reflecting a respective battery state). The variables may include achievable data rates on each of the cellular links and the cooperation link, power efficiency (energy/bit) of each link, channel conditions of each link, congestion levels of each device, mobility status of each device, and/or power efficiency (energy/bit) of the cooperation link or intralink.

In some embodiments, the system (e.g., anchor device) can use an objective function to minimize a total power consumption while meeting a target combined data rate demanded by the application (e.g., immersive communication or AI burst upload). The total power consumption may refer to the sum of power consumption of the anchor device and the collaborating device. The target combined data rate may be use case-specific, e.g., determined by the corresponding use case. In some embodiments, the system (e.g., anchor device) can solve the objective function using the variables including achievable data rates on each of the cellular links and the cooperation link, power efficiency (energy/bit) of each link, channel conditions of each link, congestion levels of each device, mobility status of each device, and/or power efficiency (energy/bit) of the cooperation link or intralink.

In some embodiments, the system (e.g., anchor device) can use an objective function to minimize the end-to-end latency of use cases (e.g., a use case where the anchor device such as smart glasses is collaborating with another collaborating device such as a watch) using variables including the delay of a cellular link of the anchor device (denoted by d1), a cellular link of the collaborating device (denoted by d2), and the cooperation link (denoted by dc), as well as the processing delay on the anchor device (denoted by dg) and the processing delay on watch (denoted by dw). In some embodiments, the system can use the objective function to minimize the maximum of the delay incurred on the path via the anchor device (denoted by (d1+dg)) and the delay incurred on the path via the collaborating device (denoted by (dc+d2+dw)). In other words, the system can seek to minimize the worst-case (maximum) of the multi-path latency components so the bottleneck path is improved. Variables of the objective function in this scenario may include achievable data rates of the cellular links and the cooperation link, power efficiency of the cellular links and the cooperation link, power limits of the anchor device and the collaborating device, channel conditions of the cellular links and the cooperation link, system congestion levels of the anchor device and the collaborating device, and/or transmission power backoff due to wearable body positions (per device). In some embodiments, the transmission power backoff due to wearable body positions may refer to an intentional reduction of the radio transmission power of a wearable device (such as AR glasses, wristbands, or pucks) based on its position on the user's body. This adjustment is made to optimize wireless performance, minimize interference, and/or comply with safety or regulatory limits.

In some embodiments, the system (e.g., preferably the anchor device, though any collaborating UE may perform a collaboration optimization) can include an optimizer configured compute collaboration decisions dynamically, using objective functions tailored to the active use case and subject to per-device and/or aggregate constraints. The optimizer may be implemented in hardware, firmware, software, or a combination thereof. In some embodiments, because the computation overhead of the optimizer may be small relative to radio power draw, anchoring the optimizer on the service endpoint (e.g., anchor device/UE) can reduce a control-plane delay and simplify application integration, but remote execution (e.g., on collaborating device/UE) can also be supported with decisions forwarded over the intralink or cooperation link.

In some embodiments, the system can use different constraints and/or device considerations depending on use cases or applications. For example, immersive communication (e.g., 3D avatar calls) may maintain low latency and medium-to-high data rates; and may use the constraint that collaboration should sustain quality of service (QoS) across mobility, handover, and/or loaded cells. AI services (e.g., multimodal, generative, agentic) with bursty uplink traffic (e.g., images/video) where dynamic split across UEs is performed may maintain low latency while adhering to power budgets. AR gaming may use robust cellular links in dynamic environments, with collaboration improving resilience and throughput.

In some embodiments, an XR/AR wearable constellation may include at least two UEs and one or more interlinks which are cellular interlinks from each UE to a base station (e.g., 5G/6G radio access). Each UE can carry a portion of the uplink/downlink traffic dictated by the collaborative split. The cellular links may experience variable channel quality due to proximity to the cell center/edge, mobility-induced Doppler, scheduling under load, and/or handover events. Intra-device links between UEs (e.g., cooperation link or intralink implementing Wi-Fi, Bluetooth, or other short-range protocols) are generally capable of higher and more stable data rates due to adjacency and favorable propagation. These links can transport inter-UE coordination signaling and/or payload fragments for aggregation/fusion at the anchor device. An anchor device, e.g., the UE hosting the final application experience, can execute collaboration logic (e.g., computing optimal collaboration parameters (e.g., split data rates) using objective functions and variables), decide traffic split across UEs, request or accept fragments over intralinks, and/or performs downlink merge and uplink partition/fusion as required. The anchor device may be selected by tracking the service endpoint (e.g., glasses for AR display; watch for watch-native UI). Example cases of dynamic multi-device collaboration may include (A) glasses collaborating with a puck/phone, (B) glasses collaborating with a watch, and (C) a puck collaborating with a watch while one of the puck and the watch tethers to glasses via intralink. In each case, collaboration can proceed even when only one of the two possible tether paths is present; and the cooperation link can coordinate traffic sharing.

In some embodiments, the system can use wearable form-factor and thermal constraints for distribution of radio workload. For example, because a puck can host more antennas with higher efficiency than a watch, the system can select the puck as a preferred bearer for power-intensive uplink segments. In another example, a watch may carry lighter traffic or serve as the anchor device for watch-native experiences.

In some embodiments, the system can perform dynamic multi-link collaboration as follows. In step 1, in some embodiments, the system can determine an anchor device/UE based on the running application and its final consumption endpoint (e.g., AR rendering on glasses). In step 2, in some embodiments, the system can obtain, gather, acquire or collect a collaboration context, such as per-link channel quality, achievable throughput, energy/bit metrics, network congestion, mobility status, antenna configuration, and/or intralink capacity. In step 3, in some embodiments, the system can select an objective function with a goal (e.g., data rate, power, latency) aligned to the active use case and current constraints (e.g., battery budgets). In step 4, in some embodiments, the system can compute or perform, based on an objective function, traffic split optimization by computing a partition of uplink/downlink payloads across one or more cellular links and one or more collaboration links. In step 5, in some embodiments, the system can compute or perform, based on an objective function, latency minimization by reducing the maximum of competing path delays (e.g., a delay in an anchor device and a first cellular link associated with the anchor device; and a delay in a cooperation link, a collaborating device, and a second cellular link associated with the collaborating device), thereby alleviating the bottleneck.

In step 6, in some embodiments, the system (e.g., collaboration layers) can communicate data between the anchor device and the base station using collaboration parameters (e.g., split data rates across different links) based on the optimization results. In some embodiments, the system can schedule a collaboration link (or intralink) to transport fragments to/from the anchor device. In some embodiments, the system (e.g., collaboration layers) can perform coordination signaling to exchange control information with the base station and/or peer UE to activate or adjust collaboration at the chosen protocol layer, including sequence coordination and/or buffer controls for PDCP/RLC variants, or application-level session controls at the transport layer. In some embodiments, the system (e.g., collaboration layers) can perform aggregation and/or fusion at the anchor device for downlink reassembly and/or uplink pre-aggregation, ensuring the application perceives a single logical flow with improved performance. In some embodiments, the system (e.g., collaboration layers) can perform adaptation reacting to topology or radio condition changes (e.g., handover, cell-edge interference) with rapid re-optimization of split and power budgets, optionally migrating the anchor device if the application endpoint changes.

Embodiments in the present disclosure have at least the following advantages and benefits. First, embodiments can provide useful techniques for orchestrating multi-UE collaboration with an application-aware anchor device, thereby delivering higher aggregate throughput than any single UE link, using simultaneous cellular interlinks and high-capacity intralink aggregation. For example, systems and methods for AR wearable collaboration can achieve higher aggregated uplink and downlink data rates.

Second, embodiments can provide useful techniques for achieving lower end-to-end latency through bottleneck-aware split and local fusion at the application endpoint. For example, systems and methos can minimize the end-to-end latency of the use cases where AR glasses are the consumer of communicated data.

Third, embodiments can provide useful techniques for achieving improved power/thermal management via distribution of radio workload across devices with heterogeneous antenna efficiencies and/or battery states. For example, systems and methods can maximize the total data rate constrained by the power consumption of collaborating UEs.

Fourth, embodiments can provide useful techniques for achieving robustness to radio dynamics including mobility, handover, cell-edge interference, and system loading, achieved through rapid adaptation at selected protocol layers.

With the foregoing in mind, the figures and description below illustrate various examples of systems and/or methods for adapting operations based on network conditions. It should be noted that the figures and description below are non-limiting examples and can be implemented as any of various other configurations while remaining within the scope of the present disclosure.

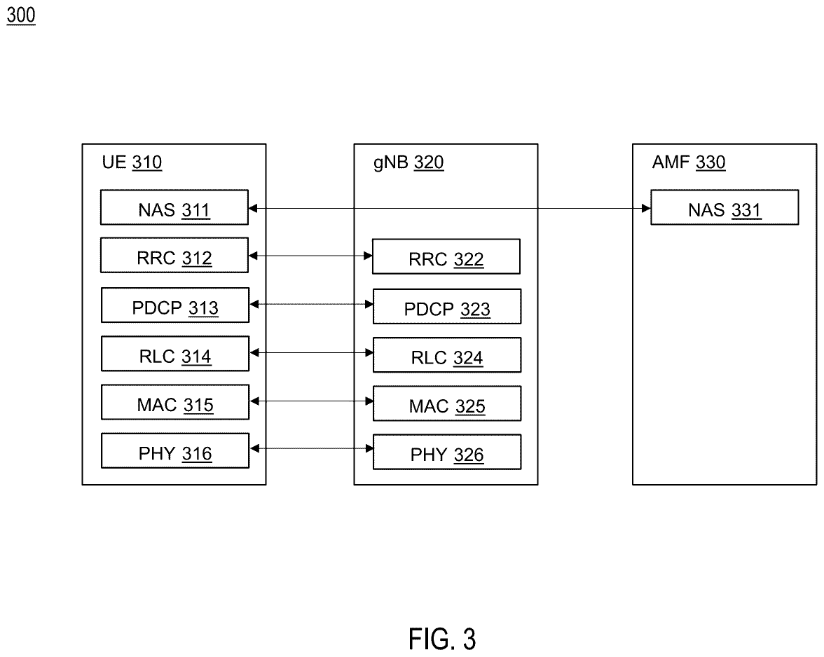

FIG. 3 is a diagram 300 showing example protocol stacks of a base station (e.g., gNB 320) and a user equipment (e.g., UE 310) in a cellular network, according to an example implementation of the present disclosure. The protocol stack of the UE 310 may include a Non-Access Stratum (NAS 311), which manages higher-level mobility and session control, and a Radio Resource Control (RRC 312) layer responsible for connection setup and maintenance. The Packet Data Convergence Protocol (PDCP 313) layer provides header compression, encryption, and integrity protection, while the Radio Link Control (RLC 314) layer segments and reassembles data, supporting error correction. The Medium Access Control (MAC 315) layer orchestrates access to the physical channel and scheduling, and the Physical (PHY 316) layer handles the transmission and reception of raw bit streams over the air interface. The gNB 320 may mirror this stack including RRC 322, PDCP 323, RLC 324, MAC 325, and PHY 326 layers, each fulfilling analogous roles in the base station context. FIG. 3 also shows Mobility Management Function (AMF 330) for core network integration which includes its own NAS 331. This layered protocol architecture enables flexible implementation of collaboration logic at various points in the stack, such as at the PDCP, RLC, MAC, or PHY layers, facilitating dynamic data split, aggregation, and signaling between collaborating UEs and the base station, according to some embodiments of the present disclosure.

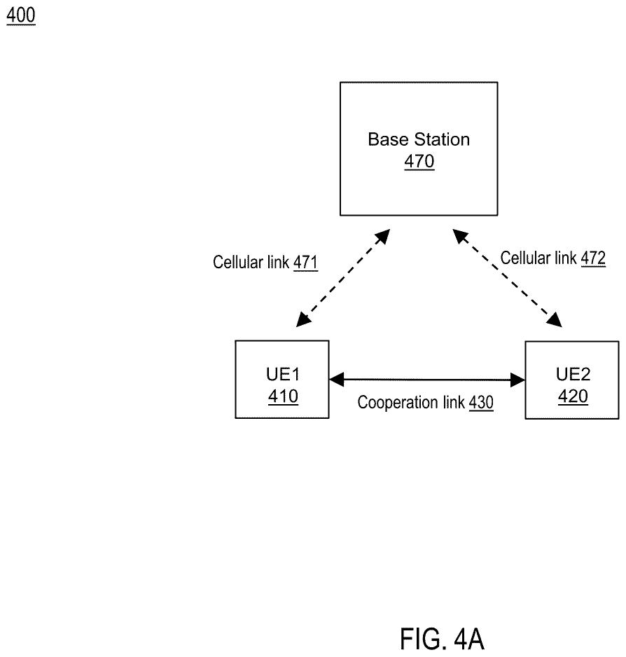

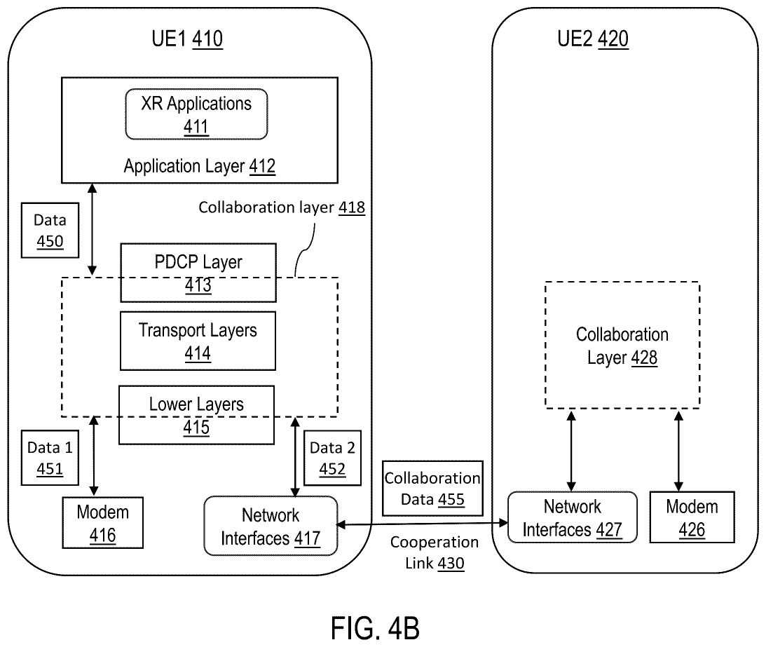

FIG. 4A is a diagram 400 showing an example of dynamic multi-device collaboration over a collaboration link, according to an example implementation of the present disclosure. FIG. 4A illustrates two collaborating UEs, UE1 410 and UE2 420. In some embodiments, each of the UEs may be XR/AR wearables such as smartphones, smart glasses, a smart watch, a puck, etc. Each UE may establish a cellular link (e.g., cellular link 471 for UE1 and cellular link 472 for UE2) with the base station 470. These cellular interlinks may be independent wireless connections to the cellular network. In addition, a cooperation link 430 may be formed directly between UE1 and UE2, utilizing short-range wireless technologies such as Wi-Fi Direct or Bluetooth. This cooperation link can enable the UEs to exchange control and payload data, supporting aggregation and fusion of traffic for improved data rate, latency, and robustness. In some embodiments, each UE 410, 420 can maintain its own cellular interlink to the base station while simultaneously participating in local collaboration via the cooperation link 430. FIG. 4B is a diagram showing an example of dynamic multi-device collaboration between two devices shown in FIG. 4A. FIG. 4B shows the internal structure of UE1 410 and UE2 420, which represent the collaborating UEs. UE1 410 may include an Application Layer 412, where XR Applications 411 operate, interfacing with the underlying protocol stack. UE1 410 may include a collaboration layer 418 which may be implemented at least one of a PDCP layer 413, transport layers 414, or lower layers 415. A modem 416 may provide connectivity to the cellular network. One or more network interfaces 417 may provide connectivity to local wireless links (e.g., cooperation link 430). The collaboration layer 418 of UE1 may coordinate, manage, or orchestrate the data split and aggregation, coordinating with network interfaces 427 and modems 426 on the UE 420. The collaboration layer 428 of UE2 can manage the partitioning and fusion of data streams, ensuring efficient utilization of both cellular and cooperation links.

Referring to FIG. 4B, UE1 may determine, based on one or more objective functions and/or collaboration data 455, respective data rates for the interlink (e.g., cellular link 471) to/from the cellular network (via the modem 416) and the cooperation link 430 to/from UE2 (via the network interfaces 417). The collaboration layer 418 may communicate the collaboration data 455 with the collaboration layer 428 of UE2. In some embodiments, the collaboration data 455 may include at least one of achievable data rate on the cooperation link and the cellular link of UE2 (e.g., cellular link 472), power efficiency (energy/bit) of the cooperation link, channel conditions of the cooperation link and the cellular link of UE2, congestion levels of UE2, and/or mobility status of UE2. UE1 (e.g., collaboration layer 418) may split or partition data 450 into data 1 (451) and data 2 (452). UE1 may wirelessly communicate data 1 (451) to the cellular network via the modem 416 at the data rate for the interlink. UE1 may wirelessly communicate data 2 (452) to UE2 via the network interfaces 417 at the data rate for the cooperation link 430. The collaboration layer 418 may integrate with the protocol stack to dynamically adapt to network conditions and application requirements.

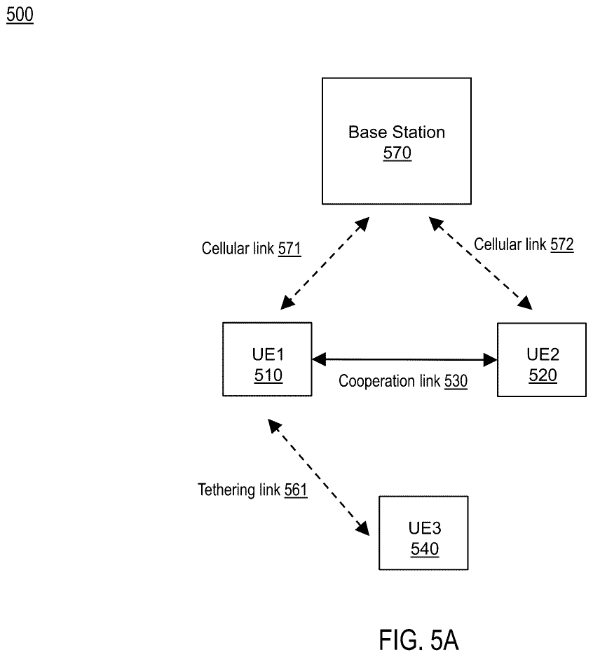

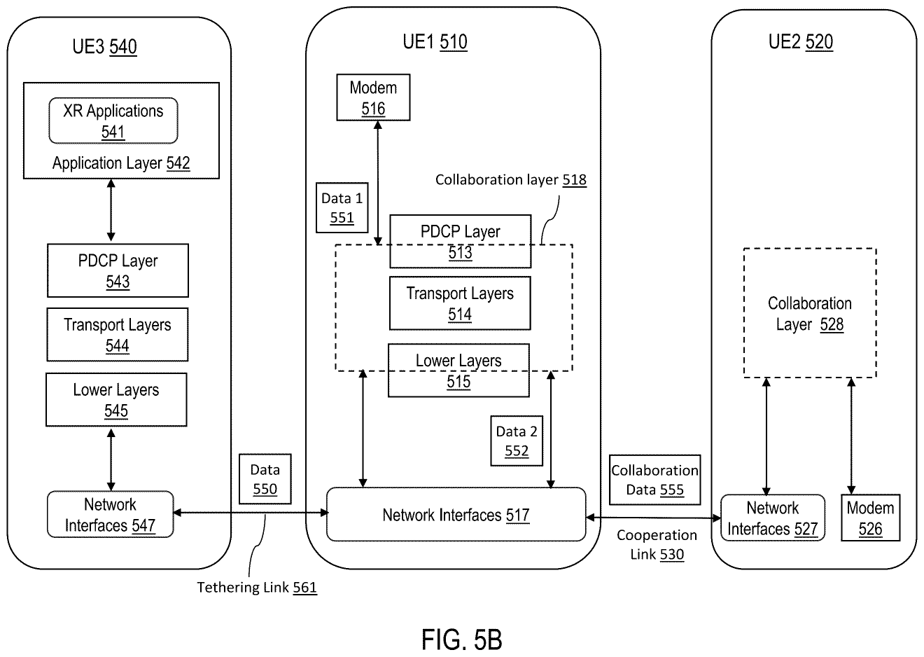

FIG. 5A is a diagram 500 showing another example of dynamic multi-device collaboration over a collaboration link, according to an example implementation of the present disclosure. FIG. 5A illustrates two collaborating UEs, UE1 510 and UE2 520. Each UE may establish a cellular link (e.g., cellular link 571 for UE1 and cellular link 572 for UE2) with the base station 570. These cellular interlinks may be independent wireless connections to the cellular network. In addition, a cooperation link 530 may be formed directly between UE1 and UE2, utilizing short-range wireless technologies such as Wi-Fi Direct or Bluetooth. This cooperation link can enable the UEs to exchange control and payload data, supporting aggregation and fusion of traffic for improved data rate, latency, and robustness. In some embodiments, each UE 510, 520 can maintain its own cellular interlink to the base station while simultaneously participating in local collaboration via the cooperation link 530. FIG. 5A also shows UE3 540 which is connected to UE1 via a tethering link 561, which may utilize Wi-Fi, Bluetooth, or USB to share connectivity or data with the other UEs. In some embodiments, each of the UEs may be XR/AR wearables such as smartphones, smart glasses, a smart watch, a puck, etc.

FIG. 5B is a diagram showing an example of dynamic multi-device collaboration between three devices shown in FIG. 5A. FIG. 5B shows the internal structure of UE3 540, which represents an anchor device (e.g., smart glasses). UE3 540 may include an Application Layer 542, where XR Applications 541 operate, interfacing with the underlying protocol stack (e.g., PDCP layer 543, transport layers 544, lower layers 545). One or more network interfaces 547 may provide connectivity to local wireless links (e.g., tethering link 561).

FIG. 5B also shows the internal structure of UE1 510 and UE2 520, which represent the collaborating UEs. UE1 510 may include a collaboration layer 518 which may be implemented at least one of a PDCP layer 513, transport layers 514, or lower layers 515. A modem 516 may provide connectivity to the cellular network (e.g., cellular link 571). One or more network interfaces 517 may provide connectivity to local wireless links (e.g., tethering link 561, cooperation link 530). The collaboration layer 518 of UE1 518 may coordinate, manage, or orchestrate the data split and aggregation, coordinating with network interfaces 527 and modems 526 on the UE 520. The collaboration layer 528 of UE2 520 can manage the partitioning and fusion of data streams, ensuring efficient utilization of both cellular and cooperation links.

Referring to FIG. 5B, UE1 510 may determine, based on one or more objective functions and/or collaboration data 555, respective data rates for the interlink (e.g., cellular link 571) to/from the cellular network (via the modem 516) and the cooperation link 530 to/from UE2 (via the network interfaces 517). In some embodiments, the data rates may be determined by UE3 540 (which is the anchor device), in which case UE3 may have a collaboration layer which establishes another cooperation links to UE1 and/or UE2. In some embodiments, the collaboration layer 518 of UE1 510 may communicate collaboration data 555 with the collaboration layer 528 of UE2. The collaboration data 555 may include at least one of achievable data rate on the cooperation link and the cellular link of UE2 (e.g., cellular link 572), power efficiency (energy/bit) of the cooperation link, channel conditions of the cooperation link and the cellular link of UE2, congestion levels of UE2, and/or mobility status of UE2.

As shown in FIG. 5B, UE3 540 may communicate data 550 with UE1 510 via the tethering link 561. In response to receiving the data 550, UE1 (e.g., collaboration layer 518) may split or partition the data 550 into data 1 (551) and data 2 (552). UE1 may wirelessly communicate data 1 (551) to the cellular network via the modem 516 at the data rate for the interlink. UE1 may wirelessly communicate data 2 (552) to UE2 via the network interfaces 517 at the data rate for the cooperation link 530. The collaboration layer 518 may integrate with the protocol stack to dynamically adapt to network conditions and application requirements.

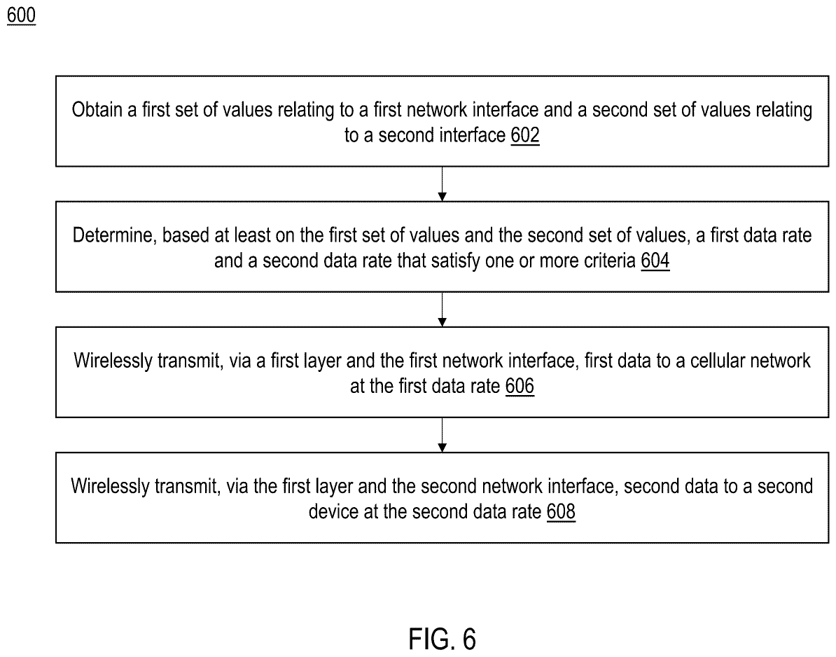

FIG. 6 is a flowchart showing a process 600 for a device to exchange data with a cellular network in collaboration with one or more other devices, according to an example implementation of the present disclosure. In some embodiments, the process 600 is performed by a first device (e.g., UE 120, 310, 410, 510, 540) including a first network interface (e.g., modem 416, 516), a second network interface (e.g., network interfaces 417, 517), a network stack, and one or more processors. The first network interface may correspond to a first wireless link (e.g., cellular link 471, 571) connected to a cellular network. The second network interface may correspond to a second wireless link (e.g., cooperation link 430, 530) connected to a second device (e.g., UE2 420, 520). The network stack may include a first layer (e.g., collaboration layer 418, 518) that configures the first and second network interfaces to communicate data with the cellular network. In some embodiments, the process 600 may be performed by a UE configured to transmit data to a base station. In some embodiments, the process 600 is performed by other entities. In some embodiments, the process 600 includes more, fewer, or different steps than shown in FIG. 6.

In some embodiments, in step 602, the one or more processors may obtain, at the first layer, a first set of values relating to the first wireless link (e.g., cellular link 471, 571) and a second set of values relating to the second wireless link (e.g., cooperation link 430, 530). In some embodiments, the one or more processors may receive, at the first layer, data relating to the second set of values from the second device (e.g., collaboration data 455, 555).

In some embodiments, the first set of values may include at least one of a channel condition of the first wireless link, achievable data rates of the first wireless link, power efficiency of the first wireless link, a congestion level of the cellular network in the first wireless link, a mobility status of the first device, an end to end latency between the first device and the cellular network, a number of antennas of the first device, or a power constraint of the first device. In some embodiments, the second set of values may include at least one of a channel condition of the second wireless link, achievable data rates of the second wireless link, power efficiency of the second wireless link, a congestion level of the cellular network between the second device and the cellular network, a mobility status of the second device, an end to end latency between the first device and the second device, an end to end latency between the first device and the cellular network via the second wireless link, an end to end latency between the second device and the cellular network, a number of antennas of the second device, or a power constraint of the second device.

In some embodiments, in step 604, the one or more processors may determine, based at least on the first set of values and the second set of values, a first data rate and a second data rate (e.g., uplink data rates) that satisfy one or more criteria. In some embodiments, the one or more criteria may include one or more objective functions defined with one or more variables. The one or more variables may relate to one or more values among the first set of values and the second set of values. The one or more objective functions may include at least one of: a function of maximizing a total data rate of the first device, constrained by a power consumption of the first device and the second device, a function of minimizing a total power consumption of the first device and the second device, constrained by a target total data rate of the first device, or a function of minimizing an end to end delay between the first device and the cellular network, constrained by at least one of (1) a power consumption of the first device and the second device, or (2) a target total data rate of the first device. In some embodiments, the first data rate and the second data rate may be determined using an objective function of the one or more objective functions, the first set of values, and the second set of values.

In some embodiments, the one or more processors may split, based at least on the first set of values and the second set of values, the data (e.g., data 450, data 550) into the first data (e.g., data 451, 551) and the second data (e.g., data 452, 552). In some embodiments, in step 606, the one or more processors may wirelessly transmit, via the first network interface (e.g., modem 416, 516), the first data (e.g., data 451, 551) to the cellular network (e.g., base station 470, 570) at the first data rate (e.g., uplink data rate). In some embodiments, in step 608, the one or more processors may wirelessly transmit, via the second network interface, the second data (e.g., data 452, 552) to the second device (e.g., UE2 420, 520) at the second data rate (e.g., uplink data rate).

In some embodiments, the one or more processors may determine, based at least on the first set of values and the second set of values, a third data rate and a fourth data rate (e.g., downlink data rates) that satisfy the one or more criteria. The one or more processors may wirelessly receive, via the first network interface, third data from the cellular network at the third data rate (e.g., downlink data rate). The one or more processors may wirelessly receive, via the second network interface, fourth data from the second device at the fourth data rate (e.g., downlink data rate).

In some embodiments, the first device may include a third network interface (e.g., one of the network interfaces 517) wirelessly connected to a third device (e.g., UE3 540). The one or more processors may wirelessly receive, via the third network interface, the data (e.g., data 550) from the third device (e.g., UE3 540). The one or more processors may split the data (e.g., data 550) received from the third device into the first data (e.g., data 1 (551)) and the second data (e.g., data 2 (552)).

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A first device comprising:
a first network interface corresponding to a first wireless link connected to a cellular network;
a second network interface corresponding to a second wireless link connected to a second device;
a network stack comprising a first layer that configures the first and second network interfaces to communicate data with the cellular network; and
one or more processors configured to:
obtain, at the first layer, a first set of values relating to the first wireless link and a second set of values relating to the second wireless link;
determine, based at least on the first set of values and the second set of values, a first data rate and a second data rate that satisfy one or more criteria;
wirelessly transmit, via the first network interface, first data to the cellular network at the first data rate; and
wirelessly transmit, via the second network interface, second data to the second device at the second data rate.

2. The first device of claim 1, wherein the one or more processors are configured to:
split, based at least on the first set of values and the second set of values, the data into the first data and the second data.

3. The first device of claim 1, wherein the one or more processors are configured to:
determine, based at least on the first set of values and the second set of values, a third data rate and a fourth data rate that satisfy the one or more criteria;
wirelessly receive, via the first network interface, third data from the cellular network at the third data rate; and
wirelessly receive, via the second network interface, fourth data from the second device at the fourth data rate.

4. The first device of claim 1, further comprising a third network interface wirelessly connected to a third device,
wherein the one or more processors are configured to:
wirelessly receive, via the third network interface, the data from the third device; and
split the data received from the third device into the first data and the second data.

5. The first device of claim 1, wherein the one or more processors are configured to:
receive, at the first layer, data relating to the second set of values from the second device.

6. The first device of claim 1, wherein
the first set of values comprises at least one of a channel condition of the first wireless link, achievable data rates of the first wireless link, power efficiency of the first wireless link, a congestion level of the cellular network in the first wireless link, a mobility status of the first device, an end to end latency between the first device and the cellular network, a number of antennas of the first device, or a power constraint of the first device.

7. The first device of claim 1, wherein
the second set of values comprises at least one of a channel condition of the second wireless link, achievable data rates of the second wireless link, power efficiency of the second wireless link, a congestion level of the cellular network between the second device and the cellular network, a mobility status of the second device, an end to end latency between the first device and the second device, an end to end latency between the first device and the cellular network via the second wireless link, an end to end latency between the second device and the cellular network, a number of antennas of the second device, or a power constraint of the second device.

8. The first device of claim 1, wherein
the one or more criteria comprise one or more objective functions defined with one or more variables, and
the one or more variables relate to one or more values among the first set of values and the second set of values.

9. The first device of claim 8, wherein the one or more objective functions comprise at least one of:
a function of maximizing a total data rate of the first device, constrained by a power consumption of the first device and the second device;
a function of minimizing a total power consumption of the first device and the second device, constrained by a target total data rate of the first device; or
a function of minimizing an end to end delay between the first device and the cellular network, constrained by at least one of (1) a power consumption of the first device and the second device, or (2) a target total data rate of the first device.

10. The first device of claim 8, wherein
the first data rate and the second data rate are determined using an objective function of the one or more objective functions, the first set of values, and the second set of values.

11. A method for a first device to communicate data with a cellular network, the first device comprising one or more processors, a first network interface corresponding to a first wireless link connected to the cellular network, a second network interface corresponding to a second wireless link connected to a second device, and a network stack comprising a first layer that configures the first and second network interfaces to communicate the data with the cellular network, the method comprising:
obtaining, by the one or more processors, at the first layer, a first set of values relating to the first wireless link and a second set of values relating to the second wireless link;
determining, by the one or more processors, based at least on the first set of values and the second set of values, a first data rate and a second data rate that satisfy one or more criteria;
wirelessly transmitting, via the first network interface, first data to the cellular network at the first data rate; and
wirelessly transmitting, via the second network interface, second data to the second device at the second data rate.

12. The method of claim 11, further comprising:
splitting, based at least on the first set of values and the second set of values, the data into the first data and the second data.

13. The method of claim 11, further comprising:
determining, based at least on the first set of values and the second set of values, a third data rate and a fourth data rate that satisfy the one or more criteria;
wirelessly receiving, via the first network interface, third data from the cellular network at the third data rate; and
wirelessly receiving, via the second network interface, fourth data from the second device at the fourth data rate.

14. The method of claim 11, wherein
the first device comprises a third network interface wirelessly connected to a third device, and
the method further comprises:
wirelessly receiving, via the third network interface, the data from the third device; and
splitting the data received from the third device into the first data and the second data.

15. The method of claim 11, further comprising:
receiving, at the first layer, data relating to the second set of values from the second device.

16. The method of claim 11, wherein
the first set of values comprises at least one of a channel condition of the first wireless link, achievable data rates of the first wireless link, power efficiency of the first wireless link, a congestion level of the cellular network in the first wireless link, a mobility status of the first device, an end to end latency between the first device and the cellular network, a number of antennas of the first device, or a power constraint of the first device.

17. The method of claim 11, wherein
the second set of values comprises at least one of a channel condition of the second wireless link, achievable data rates of the second wireless link, power efficiency of the second wireless link, a congestion level of the cellular network between the second device and the cellular network, a mobility status of the second device, an end to end latency between the first device and the second device, an end to end latency between the first device and the cellular network via the second wireless link, an end to end latency between the second device and the cellular network, a number of antennas of the second device, or a power constraint of the second device.

18. The method of claim 11, wherein
the one or more criteria comprise one or more objective functions defined with one or more variables, and
the one or more variables relate to one or more values among the first set of values and the second set of values.

19. The method of claim 18, wherein the one or more objective functions comprise at least one of:
a function of maximizing a total data rate of the first device, constrained by a power consumption of the first device and the second device;
a function of minimizing a total power consumption of the first device and the second device, constrained by a target total data rate of the first device; or
a function of minimizing an end to end delay between the first device and the cellular network, constrained by at least one of (1) a power consumption of the first device and the second device, or (2) a target total data rate of the first device.

20. The method of claim 18, wherein
the first data rate and the second data rate are determined using an objective function of the one or more objective functions, the first set of values, and the second set of values.
